(19) United States
(12) Patent Application Publication
(10) Pub. No.: US 2024/0365819 A1
(43) Pub. Date: Nov. 7, 2024

(54) COATING COMPOSITION FOR FRIED FOOD

(71) Applicant: NISSHIN SEIFUN WELNA INC., Chiyoda-ku (JP)

(72) Inventors: Hidetoshi KAWASAKI, Chuo-ku (JP); Ryosuke FUJIMURA, Chuo-ku (JP); Akito TSUJI, Chuo-ku (JP); Shuhei YAMAZAKI, Chuo-ku (JP)

(73) Assignee: NISSHIN SEIFUN WELNA INC., Chiyoda-ku (JP)

(21) Appl. No.: 18/554,099

(22) PCT Filed: Apr. 28, 2021
(86) PCT No.: PCT/JP2021/017114

§ 371 Date: Oct. 5, 2023

(51) Int. Cl. A23L 7/157; A23L 5/10

(52) U.S. Cl. CPC A23L 7/157; A23L 5/10

(57) ABSTRACT

A coating material for fried food containing an oil-and-fat processed acetylated starch. The oil-and-fat processed acetylated starch has the following properties: when the viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes, in which for the viscosity measurement of the aqueous suspension, the aqueous suspension contains 6 parts by mass of the oil-and-fat processed acetylated starch per 100 parts by mass of water, and the temperature of the aqueous suspension is first maintained at 50° C. for 1 minute, then the temperature is raised to 95° C. over 7 minutes and 30 seconds, and then the temperature is maintained at 95° C. for 5 minutes.

### TECHNICAL FIELD

The present invention relates to a coating composition for fried food.

### BACKGROUND ART

Coated fried food is a food product obtained by heating food ingredients with a coating material attached to a surface thereof in oil. The appearance and texture of the coated fried food are reduced if the binding property of the coating to the food ingredients is poor. In order to obtain the coated fried food in which the coating is appropriately bound to the food ingredients, a high degree of skill is required for a cook in operations for, for example, preparation of the coating material and attachment of the coating material to the food ingredients. The appropriately produced coated fried food has a crispy texture of coating and juiciness of food ingredients, and is very delicious. However, although the coated fried food has a good texture of coating as described above immediately after production, the coating tends to be hard and have a dry texture as long time passes after production.

Patent Literature 1 describes that a coating material containing an oil-and-fat processed starch produced from a raw material starch having a specific swelling degree, an oil-and-fat, and a pH adjusting agent improves the binding property of the food ingredients and the coating. Patent Literatures 2 and 3 describe that a batter material containing an oil-and-fat processed acetylated starch improves the binding property of the coating to the food ingredients and improves the texture of the coating in fried food and the juiciness of the food ingredients. Patent Literature 4 describes that a coating material containing an oil-and-fat processed phosphate crosslinked starch improves the binding property of the coating to the food ingredients, and improves the texture of the coating and food ingredients in fried food. Patent Literature 5 describes that a coating material containing an oil-and-fat processed starch produced from a phosphate crosslinked starch, an oil-and-fat, and a pulverized soybean improves the binding property of the coating to the food ingredients, and improves the texture of the coating in fried food. Patent Literature 6 describes that wheat flour having a peak viscosity of RVA of 4700 mPa·s or more is subject to heat treatment and the heat-treated wheat flour having a gluten vitality of 30% or less improves the binding property of the coating to the food ingredients and improves the texture and flavor of the coating in fried food. Patent Literature 7 describes that a coating material containing heat-treated wheat flour having RVA peak viscosity of 3500 to 7000 mPa·s and a gelatinization starting temperature lower than that of raw material wheat flour by 10° C. or more improves the texture of the coating in fried food.

### CITATION LIST

### Patent Literature

Patent Literature 1: JP 2016-174535 A
Patent Literature 2: JP 2002-191431 A
Patent Literature 3: JP 2012-165724 A
Patent Literature 4: JP 2007-028905 A
Patent Literature 5: JP 2012-029602 A
Patent Literature 6: JP 2010-233540 A
Patent Literature 7: WO 2017/135353 A

### SUMMARY OF INVENTION

### Technical Problem

The present invention provides a coating material for fried food that makes it possible to produce a coated fried food that improves the binding property of the coating to the food ingredients and maintains a good texture of the coating even after elapse of time from production.

### Solution to Problem

The present inventors found that the coated fried food produced using the coating material containing the oil-and-fat processed acetylated starch having a specific viscosity improved binding property of the food ingredients and the coating, and has a good texture of the coating even after elapse of time from production.

The present invention provides the following.

[1] A coating material for fried food containing an oil-and-fat processed acetylated starch,
wherein the oil-and-fat processed acetylated starch has the following properties: when the viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes, wherein for the viscosity measurement of the aqueous suspension, the aqueous suspension contains 6 parts by mass of the oil-and-fat processed acetylated starch per 100 parts by mass of water, and the temperature of the aqueous suspension is first maintained at 50° C. for 1 minute, then the temperature is raised to 95° C. over 7 minutes and 30 seconds, and then the temperature is maintained at 95° C. for 5 minutes.

[2] The coating material for fried food according to [1], containing 10 to 90 mass % of the oil-and-fat processed acetylated starch.

[3] The coating material for fried food according to [1] or [2], further containing one or more selected from the group consisting of cereal flour and other starches.

[4] A use of an oil-and-fat processed acetylated starch as a coating material for fried food,
wherein the oil-and-fat processed acetylated starch has the following properties: when the viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes, wherein for the viscosity measurement of the aqueous suspension, the aqueous suspension contains 6 parts by mass of the oil-and-fat processed acetylated starch per 100 parts by mass of water, and the temperature of the aqueous suspension is first maintained at 50° C. for 1 minute, then the temperature is raised to 95° C. over 7 minutes and 30 seconds, and then the temperature is maintained at 95° C. for 5 minutes.

[5] The use according to [4], wherein the coating material for fried food contains 10 to 90 mass % of the oil-and-fat processed acetylated starch.

[6] The use according to [4] or [5], wherein the coating material for fried food further contains one or more selected from the group consisting of cereal flour and other starches.

[7] An oil-and-fat processed acetylated starch for use as a coating material for fried food,
wherein the oil-and-fat processed acetylated starch has the following properties: when the viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes, wherein for the viscosity measurement of the aqueous suspension, the aqueous suspension contains 6 parts by mass of the oil-and-fat processed acetylated starch per 100 parts by mass of water, and the temperature of the aqueous suspension is first maintained at 50° C. for 1 minute, then the temperature is raised to 95° C. over 7 minutes and 30 seconds, and then the temperature is maintained at 95° C. for 5 minutes.

[8] The oil-and-fat processed acetylated starch according to [7], wherein the coating material for fried food contains 10 to 90 mass % of the oil-and-fat processed acetylated starch.

[9] The oil-and-fat processed acetylated starch according to [7] or [8], wherein the coating material for fried food further contains one or more selected from the group consisting of cereal flour and other starches.

[10] A method for producing a coated fried food, the method including:
preparing food ingredients to which a coating material for fried food containing an oil-and-fat processed acetylated starch has been attached; and
deep-frying the food ingredients,
wherein the oil-and-fat processed acetylated starch has the following properties: when the viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes, wherein for the viscosity measurement of the aqueous suspension, the aqueous suspension contains 6 parts by mass of the oil-and-fat processed acetylated starch per 100 parts by mass of water, and the temperature of the aqueous suspension is first maintained at 50° C. for 1 minute, then the temperature is raised to 95° C. over 7 minutes and 30 seconds, and then the temperature is maintained at 95° C. for 5 minutes.

[11] The method according to [10], wherein the coating material for fried food contains 10 to 90 mass % of the oil-and-fat processed acetylated starch.

[12] The method according to [10] or [11], wherein the coating material for fried food further contains one or more selected from the group consisting of cereal flour and other starches.

[13] The method according to any one of [10] to [12], further including attaching an additional coating material to the food ingredients to which the coating material for fried food containing the oil-and-fat processed acetylated starch has been attached.

### Advantageous Effects of Invention

The coating material for fried food of the present invention improves the binding property of the food ingredients and the coating. In addition, the coated fried food produced using the coating material for fried food of the present invention has a good short and crispy texture of the coating even after elapse of time from production.

### DESCRIPTION OF EMBODIMENTS

The present invention provides a coating material for fried food. The coating material for fried food of the present invention contains an oil-and-fat processed acetylated starch having a specific viscosity.

The acetylated starch is a processed starch in which a hydroxyl group of starch and acetic acid are esterified, the starch has a large number of hydroxyl groups derived from glucose residues, and the properties of the acetylated starch to be obtained vary depending on the position and number (degree of substitution) of hydroxyl groups to be substituted. The acetylated starch can be produced by applying acetic anhydride or vinyl acetate to a raw material starch, and acetylated starches having different substitution positions and degrees of substitution depending on reaction conditions can be produced.

An oil-and-fat processed starch is a processed starch prepared by mixing a raw material starch and an oil-and-fat and then heating or drying the mixture. For example, the oil-and-fat processed starch can be produced by adding the raw material oil-and-fat in an amount of about 0.01 to 0.5 parts by mass, preferably 0.05 to 0.2 parts by mass, to 100 parts by mass of the raw material starch, mixing the mixture until it becomes uniform, and heating, drying, or heating and drying the obtained mixture at 40 to 180° C. When mixing the raw material starch with the oil-and-fat, an emulsifier may be added in advance or simultaneously with the oil-and-fat. However, in the present invention, it is preferable not to add an emulsifier in order to obtain an oil-and-fat processed starch with desired viscosity in the present invention described later.

The oil-and-fat processed acetylated starch used in the present invention can be prepared by acetylating a raw material starch and subjecting it to oil-and-fat processing as described above. In the preparation of the oil-and-fat processed acetylated starch used in the present invention, the acetylation of the starch and the oil-and-fat processing may be performed continuously in a series of steps, or may be performed in separate steps. Alternatively, the oil-and-fat processed acetylated starch used in the present invention can be prepared by subjecting a commercially available acetylated starch to oil-and-fat processing.

The type of the raw material starch of the oil-and-fat processed acetylated starch is not particularly limited, and include, for example, unprocessed starches, such as corn starch, waxy corn starch, tapioca starch, potato starch, wheat starch, rice starch. These raw material starches can be used alone or in combination of two or more thereof.

The type of the raw material oil-and-fat of the oil-and-fat processed acetylated starch is not particularly limited, and include, for example, edible vegetable oil-and-fat and animal oil-and-fat, such as soybean oil, rapeseed oil, cottonseed oil, safflower oil, sunflower oil, rice oil, corn oil, palm oil, perilla oil, beef tallow, and lard. These oils-and-fats can be used alone or in combination of two or more thereof.

The oil-and-fat processed acetylated starch used in the present invention may be subjected to other processing treatment that can be performed on an edible starch in addition to the above acetylation and oil-and-fat processing as long as the effect of the present invention is not inhibited. Examples of the other processing treatments include chemical treatments such as esterification other than acetylation, etherification, crosslinking, oxidation, and pregelatinization, as well as physical treatments such as pulverization, classification, heating and drying. These other processing treatments can be performed alone or in combination of two or more thereof.

The oil-and-fat processed acetylated starch used in the present invention has the following properties: when the viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes, for the viscosity measurement of the aqueous suspension, the aqueous suspension contains 6 parts by mass of the oil-and-fat processed acetylated starch per 100 parts by mass of water, and the temperature of the aqueous suspension is first maintained at 50° C. for 1 minute, then the temperature is raised to 95° C. over 7 minutes and 30 seconds, and then the temperature is maintained at 95° C. for 5 minutes.

The Rapid Visco Analyzer (RVA) is a device that measures the viscosity of a suspension of starch or cereal flour. In the viscosity measurement by RVA, a suspension of starch or cereal flour (object to be measured) is filled in a container with a paddle (stirring bar), the paddle is rotated, and the viscosity of the object is measured by measuring the resistance force of the paddle. At this time, by measuring the viscosity while heating the container, the viscosity change associated with the pregelatinization of starch or cereal flour can be measured. RVA devices are commercially available, and RVA is widely used, for example, for quality inspection of foods containing a large amount of starch.

An example of the procedure for measuring the viscosity of starch by RVA is described below.

After adding 1.5 g in terms of dry mass of the starch to be measured and 25 mL of distilled water to an aluminum can (container for the object to be measured) attached to a Rapid Visco Analyzer (RVA) (for example, Series 4 RVA-4 manufactured by Newport Scientific Inc.), a paddle (stirring bar) attached to the device is placed, and the aluminum can is set on the tower of the device. While the paddle is rotated at a rotation speed of 160 rpm/min, the contents of the aluminum can (aqueous suspension containing starch) are heated and the viscosity thereof is measured. The heating conditions are such that the aqueous suspension is first maintained at a temperature of 50° C. for 1 minute, then raised to a temperature of 95° C. over 7 minutes and 30 seconds, and maintained at the same temperature for 5 minutes. If necessary, the aqueous suspension is cooled to a temperature of 50° C. over a further 7 minutes and 30 seconds, and then maintained at the same temperature for 2 minutes. The viscosity of the aqueous suspension during this heating period is measured, and the viscosity of the aqueous suspension when reaching 95° C. and the viscosity of the aqueous suspension immediately after maintaining at 95° C. for 5 minutes are obtained. The “viscosity of starch by RVA (or RVA viscosity)” as used herein is the viscosity obtained by measuring an aqueous suspension containing 6 parts by mass of the starch by RVA according to the above procedure.

In the RVA viscosity change curve of a general starch, as shown in FIG. 1 of Patent Literature 3, the RVA viscosity of the starch reaches a maximum peak while the temperature is raised from 50° C. to 95° C., and then decreases, and then further decreases while being maintained at 95° C. On the other hand, the oil-and-fat processed acetylated starch used in the present invention is characterized in that the RVA viscosity does not show a peak during heating from 50° C. to 95° C., and the viscosity further increases after reaching 95° C. It is considered that such a viscosity change during heating of the oil-and-fat processed acetylated starch used in the present invention contributes to the binding property of the food ingredients and the coating and the maintenance of the texture of the coating after a lapse of time, which are the effects of the present invention. Preferably, in the RVA viscosity change curve of the oil-and-fat processed acetylated starch used in the present invention, the viscosity when reaching 95° C. (viscosity A) is 500 to 1200 cp, more preferably 600 to 1100 cp, and the viscosity immediately after maintaining at 95° C. for 5 minutes (viscosity B) is 600 to 1500 cp, more preferably 700 to 1300 cp. Also preferably, the oil-and-fat processed acetylated starch used in the present invention has a viscosity B higher than a viscosity A by 75 cp or more. A batter liquid produced using an oil-and-fat processed acetylated starch having such a viscosity is preferable because operability when the batter liquid is attached to food ingredients is improved.

The oil-and-fat processed acetylated starch having viscosity described above can be produced without excessive trial and error by appropriately changing the type of raw material starch, the conditions of acetylation, and the conditions of oil-and-fat processing, and confirming the viscosity change curve by RVA of the obtained oil-and-fat processed acetylated starch by the above procedure.

The above oil-and-fat processed acetylated starch can be used as a component of a coating material for fried food. Therefore, the present invention provides a coating material for fried food containing the oil-and-fat processed acetylated starch. The coating material for fried food of the present invention may be made of the oil-and-fat processed acetylated starch, however preferably, the coating material for fried food of the present invention is a composition containing the oil-and-fat processed acetylated starch. The composition contains preferably 5% by mass or more, more preferably 10 to 90% by mass, still more preferably 20 to 80% by mass, and still more preferably 25 to 75% by mass of the oil-and-fat processed acetylated starch.

Preferably, the coating material for fried food of the present invention further contains one or more selected from the group consisting of cereal flour and starches other than the oil-and-fat processed acetylated starch described above. Examples of the cereal flour include, but are not limited to, for example, wheat flour, rice flour, and corn flour. Examples of the other starches include, for example, unprocessed starches, such as potato starch, wheat starch, rice starch, corn starch, waxy corn starch, and tapioca starch, and processed starches thereof (other than the oil-and-fat processed acetylated starch of the present invention). These cereal flours and other starches can be used alone or in combination of two or more thereof. The total content of the cereal flour and other starches in the coating material for fried food of the present invention is preferably 95 mass % or less, more preferably 90 mass % or less, still more preferably 80 mass % or less, and still more preferably 75 mass % or less.

The coating material for fried food of the present invention may further contain other components to be used for the coating material for fried food, as necessary, in addition to the oil-and-fat processed acetylated starch, the cereal flour, and other starches described above. Examples of the other components include, but are not limited to, for example; sugars; proteins such as egg powder and egg white powder; gelling agents; thickeners; seasonings such as amino acids; spices; flavors; powdered oils-and-fats; swelling agents and the like. The coating material for fried food of the present invention can contain any one of, or a combination of two or more of the other components depending on the type of food ingredients or coating material to be used in the desired fried food. The content of the other components in the coating material for fried food of the present invention may be the balance of the oil-and-fat processed acetylated starch, cereal flour, and other starches, however is preferably 25 mass % or less, more preferably 15 mass % or less, and still more preferably 10 mass % or less.

The coating material for fried food of the present invention can be used as a coating material in the production of coated fried foods, for example, tempura, deep-fried food, fritter, croquette, and cutlet. Preferably, the coating material for fried food of the present invention of the present invention is powdery or granular, and can be used as a raw material powder of a batter liquid for battered fried food, for example, tempura, deep fried food, flitter, croquette, and cutlet, or can be used as a breader for deep-fried food. Therefore, embodiments of the coating material for fried food of the present invention include, for example, tempura flour, deep frying flour, fritter flour, and raw material flour of the batter liquid for breaded fried food.

When a battered fried food is produced using the coating material for fried food according to the present invention, the coated fried food is produced by attaching the coating material for fried food to food ingredients and then deep-frying them. Examples of the coated fried food produced according to the present invention include, for example, tempura, deep-fried food, flitter, and breaded fried foods such as croquette, and cutlet. The ingredients used for producing the battered fried food are not particularly limited, however include, for example, meats such as chicken, pork, beef, sheep, and goat; seafoods such as squid, shrimp, horse mackerel; and vegetables. Since the coating material for fried food of the present invention can improve the binding property of food ingredients and the coating, the coating material for fried food is preferably applied to food ingredients that are easily shrunk by heating (as a result, the coating is easily peeled off), for example, meats and seafoods.

As a procedure for attaching the coating material for fried food of the present invention to food ingredients, a usual method may be used. For example, the powdery or granular coating material for fried food may be attached to food ingredients, or a batter liquid containing the coating material for fried food may be prepared, and the batter liquid may be attached to the food ingredients. The food ingredients to which the coating material for fried food of the present invention is attached may be seasoned in advance or may be dusted with flour as necessary. On the other hand, it is preferable that a batter liquid or a breader is not attached in advance to the food ingredients to which the coating material for fried food of the present invention is attached.

For example, when the coating material for fried food of the present invention is powdery or granular, the coating material can be attached to the food ingredients, for example, by sprinkling the coating material from above the food ingredients, rubbing the coating material against the food ingredients, putting the coating material and the food ingredients into a bag and closing the bag and shaking the bag, rolling the food ingredients on the coating material spread on a container such as a dish, pressing the food ingredients from on the coating material.

Also, for example, when the batter liquid containing the coating material for fried food of the present invention is used, the coating material can be attached to the food ingredients, for example, by immersing the food ingredients in the batter liquid, spraying the batter liquid on the food ingredients, applying the batter liquid to the food ingredients using a brush and the like. The batter liquid containing the coating material for fried food of the present invention can be prepared by mixing the coating material for fried food with a liquid, for example, water or egg liquid. For example, 50 to 200 parts by mass of water may be added to and mixed with 100 parts by mass of the coating material for fried food. At that time, it is preferable that the viscosity of the batter liquid at 25° C. is in the range of 100 to 5000 cp from the viewpoint of operability. The viscosity of the batter liquid in the present specification is a value measured with a B-type viscometer (TVB-10 viscometer, manufactured by Toki Sangyo Co., Ltd.) in accordance with JIS Z 8803 “Methods for viscosity measurement of liquid”.

In one embodiment, another coating material may be further attached to the food ingredients to which the coating material for fried food of the present invention is attached. For example, a breaded fried food can be produced by further attaching breadcrumbs to the food ingredients to which the batter liquid containing the coating material for fried food of the present invention is attached and deep-frying them. In another embodiment, the food ingredients to which the coating material for fried food of the present invention is attached are deep-fried without attaching another coating material. Examples of the coated fried food produced by such a procedure include, for example, tempura, deep-fried food.

A coated fried food is produced by deep-frying food ingredients to which the coating material for fried food of the present invention is attached. A usual technique for deep-frying can be used, for example, deep-frying with a large amount of oil and shallow frying with a small amount of oil. Alternatively, the food ingredients to which the coating material for fried food of the present invention is attached can be stored refrigerated, chilled, or frozen without deep-frying, and then deep-fried as appropriate suitable time. The coated fried food thus produced may be eaten as it is, or may be stored at room temperature, refrigerated, chilled, or frozen, and then reheated and eaten.

### EXAMPLES

Hereinafter, the present invention will be described in more detail with reference to Examples, however the present invention is not limited to the following Examples.

### Preparation Example 1: Preparation of Processed Starch

### (Preparation of Acetylated Starch)

An acetylated starch was produced according to a conventional method. 200 g of a raw material starch (tapioca starch) was placed in a container, water was added thereto, and the mixture was well stirred and dispersed to obtain a starch dispersion liquid having a concentration of 40 (w/v) %. A 4% aqueous sodium hydroxide solution was added to this dispersion to adjust the pH to 10.5, vinyl acetate was added thereto, and the mixture was stirred at 35° C. to react. The added vinyl acetate was 6 g, 8 g or 10 g. The stirring time was adjusted within a range of 2 to 4 hours. After confirming that the pH value of the reactant was decreased to 7 or less, 6 or less, or 5 or less, the reactant was filtered, and the filtrate was collected and dispersed in 3 L of water and washed. The filtrate was filtered and washed twice in the same manner, followed by further washing with methanol and air-drying in a drying oven at room temperature.

### (Preparation of Phosphate Crosslinked Starch)

A phosphate crosslinked starch was produced according to a conventional method. 200 g of a raw material starch (tapioca starch) was placed in a container, water was added thereto, and the mixture was well stirred and dispersed to obtain a starch dispersion liquid having a concentration of 40 (w/v) %. 2 g of sodium sulfate was added to this dispersion, and a 3% aqueous sodium hydroxide solution was further added to adjust the pH to 11, and then 0.05 g or 0.1 g of phosphorus oxychloride was added, and the mixture was stirred at 35° C. for 1 hour to react. The reaction was terminated by adding 9% hydrochloric acid to adjust the pH to 5, the reactant was filtered, and the filtrate was collected and dispersed in 3 L of water and washed. The filtrate was filtered and washed twice in the same manner, followed by further washing with methanol and air-drying in a drying oven at room temperature.

### (Preparation of Oil-and-Fat Processed Starch)

To the acetylated starch or phosphate crosslinked starch prepared above, 0.1 part by mass, 0.2 part by mass or 0.5 part by mass of corn oil or safflower oil was added and mixed well, and then dried in a thermostatic chamber at 100° C. for various times to produce an oil-and-fat processed starch. The oil-and-fat amount used in the following examples and comparative examples was selected by measuring the RVA viscosity as follows from the oil-and-fat processed starch produced as described above.

### (RVA Viscosity Measurement)

The viscosity of each processed starch obtained was measured by RVA according to the following procedure. After adding 1.5 g of the starch in terms of dry mass to be measured and 25 mL of distilled water to an aluminum can attached to RVA (Series 4 RVA-4 manufactured by Newport Scientific Inc.), a paddle (stirring bar) attached to the device was placed, and the aluminum can was set on the tower of the device. While the paddle was rotated at a rotation speed of 160 rpm/min, the contents of the aluminum can (aqueous suspension containing starch to be measured) were heated and the viscosity thereof was measured. Upon heating, the aqueous suspension was first maintained at a temperature of 50° C. for 1 minute, then raised to a temperature of 95° C. over 7 minutes and 30 seconds, and maintained at the same temperature for 5 minutes, and then cooled to a temperature of 50° C. over 7 minutes and 30 seconds, and maintained at the same temperature for 2 minutes. The viscosity of the aqueous suspension during this heating period is measured, and the viscosity (viscosity A) of the aqueous suspension when reaching 95° C. and the viscosity (viscosity B) of the aqueous suspension immediately after maintaining at 95° C. for 5 minutes were obtained.

### Test Example 1: Production of Fried Shrimp

50 parts by mass of each processed starch obtained in Preparation Example 1 and 50 parts by mass of wheat flour (soft wheat flour) were well mixed to produce a coating material. 170 parts by mass of cold water was mixed with the obtained coating material to prepare a batter liquid. The viscosity of each batter liquid at 25° C. was in the range of 100 to 5000 cp (measured with TVB-10 viscometer manufactured by Toki Sangyo Co., Ltd.). Soft wheat flour was attached thinly and evenly to the entire surface of shelled shrimp (1 shrimp: 30 g) as dusting powder. The fried shrimp to which the dusting powder had been attached was passed through the batter liquid, and then breaded, and deep-fried with vegetable oil heated to 170° C. for 2 minutes to produce fried shrimp. The produced fried shrimp was roughly cooled and stored in a refrigerator for 24 hours, and then stored at room temperature (about 25° C.) for 1 hour. The preserved fried shrimp was cut with a kitchen knife, and the binding property of the coating to the food ingredients (shrimp) at that time was evaluated according to the following evaluation criteria. In addition, the texture of the coating of fried shrimp after storage was evaluated by 10 expert panelists according to the following evaluation criteria, and the average score of the evaluations of 10 panelists was obtained.

### Evaluation Criteria

### (Binding Property of Coating)

Score 5: The coating is not peeled off from the food ingredients at all even when the fried shrimp is cut with a kitchen knife, and extremely good.

Score 4: The coating is hardly peeled off from the food ingredients even when the fried shrimp is cut with a kitchen knife, and good.

Score 3: When the fried shrimp is cut with a kitchen knife, the coating is peeled off from the food ingredients at a portion corresponding to 10 to 20% of the entire circumference of the cut surface.

Score 2: When the fried shrimp is cut with a kitchen knife, the coating is peeled off from the food ingredients at a portion corresponding to more than 20% to 50% or less of the entire circumference of the cut surface, and poor.

Score 1: When the fried shrimp is cut with a kitchen knife, the coating is peeled off from the food ingredients at a portion corresponding to more than 50% of the entire circumference of the cut surface, and extremely poor.

### (Texture of Coating)

Score 5: The texture of the coating is very short and crispy, and extremely good.

Score 4: The texture of the coating is short and crispy, and good.

Score 3: The texture of the coating is not short and crispy enough.

Score 2: The texture of the coating is not short and crispy, moreover is dry and gritty, and poor.

Score 1: The texture of the coating is not short and crispy at all, moreover is very dry and gritty, and extremely poor.

The viscosity of the processed starch used in the production of fried shrimp measured in Preparation Example 1 and the evaluation results of the produced fried shrimp are shown in Table 1.

TABLE 1

| Composition of batter | Example | | | Comparative Example | | | | | | | | |
|---|---|---|---|---|---|---|---|---|---|---|---|---|
| (parts by mass) | 1 | 2 | 3 | 1 | 2 | 3 | 4 | 5 | 6 | 7 | 8 | 9 |
| Processed starch | | | | | | | | | | | | |
| Oil-and-fat processed | 50 | 50 | 50 | 50 | 50 | 50 | | | | | | |
| acetylated starch | | | | | | | | | | | | |
| Oil-and-fat processed | | | | | | | 50 | 50 | 50 | | | |
| phosphate crosslinked | | | | | | | | | | | | |
| starch | | | | | | | | | | | | |
| Acetylated starch | | | | | | | | | | 50 | 50 | |
| Phosphate crosslinked | | | | | | | | | | | | 50 |
| starch | | | | | | | | | | | | |
| Viscosity A*¹ of the | 820 | 660 | 1050 | 1230 | 990 | 830 | 80 | 260 | 450 | 810 | 1030 | 550 |
| processed starch (cp) | | | | | | | | | | | | |
| Viscosity B*² of the | 1040 | 790 | 1210 | 1010 | 780 | 710 | 110 | 320 | 660 | 500 | 740 | 610 |
| processed starch (cp) | | | | | | | | | | | | |
| Wheat flour | 50 | 50 | 50 | 50 | 50 | 50 | 50 | 50 | 50 | 50 | 50 | 50 |
| Total | 100 | 100 | 100 | 100 | 100 | 100 | 100 | 100 | 100 | 100 | 100 | 100 |
| Binding property of | 4.6 | 4.3 | 4.4 | 3.2 | 3.0 | 2.9 | 3.0 | 3.3 | 3.5 | 2.8 | 3.0 | 2.2 |
| coating | | | | | | | | | | | | |
| Texture of coating | 4.5 | 4.2 | 4.3 | 2.0 | 1.8 | 1.7 | 1.9 | 2.0 | 1.9 | 1.3 | 1.4 | 1.2 |

*¹Viscosity A: viscosity when reaching 95° C.
*²Viscosity B: viscosity immediately after maintaining at 95° C. for 5 minutes

### Test Example 2: Production of Fried Shrimp

A fried shrimp was produced and evaluated in the same manner as in Test Example 1, except that the composition of the coating material was changed as shown in Table 2. The results are shown in Table 2. Also, the results of Example 1 are shown again in Table 2.

TABLE 2

| Composition of coating material | Example | | | | | | | | |
|---|---|---|---|---|---|---|---|---|---|
| (parts by mass) | 4 | 5 | 6 | 7 | 1 | 8 | 9 | 10 | 11 |
| Oil-and-fat processed | 5 | 10 | 20 | 25 | 50 | 75 | 80 | 90 | 95 |
| acetylated starch | | | | | | | | | |
| Viscosity A*¹ (cp) | 820 | 820 | 820 | 820 | 820 | 820 | 820 | 820 | 820 |
| Viscosity B*² (cp) | 1040 | 1040 | 1040 | 1040 | 1040 | 1040 | 1040 | 1040 | 1040 |
| Wheat flour | 95 | 90 | 80 | 75 | 50 | 25 | 20 | 10 | 5 |
| Total | 100 | 100 | 100 | 100 | 100 | 100 | 100 | 100 | 100 |
| Binding property of coating | 3.6 | 3.8 | 4.0 | 4.2 | 4.6 | 4.3 | 4.1 | 4.0 | 3.9 |
| Texture of coating | 3.5 | 3.7 | 4.1 | 4.2 | 4.5 | 4.1 | 3.9 | 3.6 | 3.4 |

*¹Viscosity A: viscosity when reaching 95° C.
*²Viscosity B: viscosity immediately after maintaining at 95° C. for 5 minutes

1: A coating material comprising an oil-and-fat processed acetylated starch,
wherein the oil-and-fat processed acetylated starch has the following properties:
when a viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes,
wherein for the viscosity measurement of the aqueous suspension, the aqueous suspension contains 6 parts by mass of the oil-and-fat processed acetylated starch per 100 parts by mass of water, and a temperature of the aqueous suspension is first maintained at 50° C. for 1 minute, then the temperature is raised to 95° C. over 7 minutes and 30 seconds, and then the temperature is maintained at 95° C. for 5 minutes.

2: The coating material according to claim 1, comprising 10 to 90 mass % of the oil-and-fat processed acetylated starch.

3: The coating material according to claim 1, further comprising one or more selected from the group consisting of cereal flour and other starches.

4-9. (canceled)

10: A method for producing a coated fried food, the method comprising:
preparing food ingredients to which a coating material comprising an oil-and-fat processed acetylated starch is adhered; and
deep-frying the food ingredients,
wherein the oil-and-fat processed acetylated starch has the following properties:
when a viscosity of an aqueous suspension containing the oil-and-fat processed acetylated starch is measured by a Rapid Visco Analyzer (RVA), the viscosity of the aqueous suspension when reaching 95° C. is lower than the viscosity of the aqueous suspension immediately after being maintained at 95° C. for 5 minutes,
wherein for the viscosity measurement of the aqueous suspension, the aqueous suspension contains 6 parts by mass of the oil-and-fat processed acetylated starch per 100 parts by mass of water, and a temperature of the aqueous suspension is first maintained at 50° C. for 1 minute, then the temperature is raised to 95° C. over 7 minutes and 30 seconds, and then the temperature is maintained at 95° C. for 5 minutes.

11: The method according to claim 10, wherein the coating material contains comprises 10 to 90 mass % of the oil-and-fat processed acetylated starch.

12: The method according to claim 10, wherein the coating material further comprises one or more selected from the group consisting of cereal flour and other starches.

13: The method according to claim 10, farther comprising attaching an additional coating material to the food ingredients to which the coating material containing comprising the oil-and-fat processed acetylated starch is attached.
